(19) United States
(12) Patent Application Publication
(10) Pub. No.: US 2008/0197018 A1
(43) Pub. Date: Aug. 21, 2008

(54) DEVICE WITH A PRE-DEFINED AND GUIDED CAPILLARY FILL DESIGN

(76) Inventor: Jin Han, Markham (CA)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/675,945

(22) Filed: Feb. 16, 2007

(51) Int. Cl. G01N 27/26

(52) U.S. Cl. 204/412

(57) ABSTRACT

The present invention discloses a device with a predefined capillary fill design comprising a substrate (1), a working electrode (2), a reference electrode (3), a functional electrode (4), a reaction chamber (5) and a plastic covering film (6), wherein the reaction chamber (5) is provided with one or more hydrophilic guiding channels extending from the entrance of the reaction chamber (5). Therefore, the device according to the invention may be easily manufactured and operated with a high accuracy, without the need to provide a delicate hydrophilic film with special coating.

### TECHNICAL FIELD

The present invention relates to an advanced capillary fill design, and more particularly to a pre-defined and guided capillary fill design for a medical device such as a biosensor, or for any other advanced devices using capillary mechanism to fill a small chamber for quantitative and qualitative analysis.

### BACKGROUND

In recent years, biosensors have been rapidly developed to detect all kinds of diseases. A conventional biosensor is provided with a rectangular substrate with two adjacent graphite electrodes, which are substantially parallel with each other, attached thereon. A reference electrode and a functional electrode are correspondingly attached to these two graphite electrodes, with a protective plastic film, such as a PET film, arranged thereon. The working electrode may perform an enzyme catalytic reaction, and electrons so produced are transferred to electrodes via an electron carrier. Since the intensity of this electric current is relevant to the activity of the enzyme and the concentration of a particular ingredient (such as glucose) in the test sample, this particular ingredient (such as concentration of the glucose) may be readily detected by said biosensor. During operation, testing solution is sucked into a reaction chamber, in which the enzyme electrode is disposed, through capillary action. Accordingly, hydrophilic films have to be provided in the reaction chamber so that a testing solution may reach into the chamber. However, plastic as PET is usually hydrophobic, so that it has to be surface treated to form a hydrophilic coating. This hydrophilic coating will gradually lose its hydrophilic function as time goes on, especially in severe environment. Meanwhile, this hydrophilic coating may not work in aggressive environment, such as under high humidity, and may get damaged easily.

Another problem for a conventional biosensor is that manufacturing thereof is relatively complex. For a conventional biosensor, it is necessary to provide a breath space or a hole at the end of the reaction chamber. Otherwise, pressure will be built up within the chamber immediately after testing solution is applied, therefore creating a resistance to stop the testing solution from further entering into the reaction chamber. Furthermore, these breath spaces or holes may easily get blocked, therefore deteriorating the functionality of the biosensor and increasing the analytical error.

Surface treatment, as well formation of breath spaces or holes in a biosensor complicates the manufacturing process of the biosensor, increases the cost thereof, and makes it damageable.

### SUMMARY OF THE INVENTION

Therefore, an object of the present invention is to provide a novel pre-defined and guided capillary fill design for a medical device or any other advanced devices using capillary mechanism to fill a small chamber for quantitative and qualitative analysis, which may be easily manufactured and operated with a high accuracy, without the need for a delicate hydrophilic coating on hydrophobic plastic film.

According to one aspect of the present invention, a device with a predefined capillary fill design comprises a substrate, a working electrode, a reference electrode, a functional electrode, a reaction chamber and a plastic covering film, wherein the reaction chamber is provided with one or more hydrophilic guiding channels extending from the entrance of the reaction chamber.

Preferably, the hydrophilic guiding channel is formed by depositing any hydrophilic ingredient on the substrate, such as by thick film printing, injection printing, spraying, or other coating methods.

Preferably, the hydrophilic ingredient is an enzyme catalytic reaction reagent. Optionally, the hydrophilic ingredient is a mixture of surfactant and enzyme catalytic reaction reagent.

Preferably, the height of the reaction chamber is within the range of 0.001 mm to 1 mm and the length of the hydrophilic guiding channel is no less than 0.5 mm.

Preferably, the entrance of the reaction chamber may be configured to be circular, semi-circular, elliptical, semi-elliptical, rectangular, square, triangular, trapezoidal or any other suitable shapes or a combination thereof within the region of reaction chamber.

Preferably, the electrodes in the present invention such as the reference electrode and the functional electrode are made by dispersing powder materials from micrometer scale down to nanometer range in macromolecular solutions whereby developing congeries and cavities within nanometer range therein.

Preferably, the plastic covering film is a normal hydrophobic plastic film such as a PET film with a thickness of in the range of 0.05 mm to 1 mm. And optionally, the plastic covering film is transparent, semi-transparent or opaque with or without color.

### BRIEF DESCRIPTION OF THE DRAWINGS

Hereinafter, the present invention will be further described in detail with reference to the accompanying drawings.

FIG. 1 illustrates a front view of a capillary fill device according to an embodiment of the present invention, with the top plastic film removed from the device.

FIG. 2 illustrates a front view of the capillary fill device according to the embodiment of the present invention, with the top plastic film applied on the device.

FIG. 3 illustrates a side view of the capillary fill device according to the embodiment of the present invention.

### DETAILED DESCRIPTION OF THE EMBODIMENTS

A capillary fill biosensor, which is an example of the capillary fill device according to one embodiment of the present invention, is employed to measure the concentration of glucose within blood. As shown in Figures, the capillary fill biosensor according to the present invention comprises: a substrate 1; a working electrode 2; a reference electrode 3; a functional electrode 4; a reaction chamber 5; and a plastic covering film 6. The reaction chamber 5 is provided with one or more (only one is shown in the figures) hydrophilic guiding channels extending from the entrance of the reaction chamber. The testing solution such as blood sample to be tested flows to the reaction chamber 5 through the one or more channels via capillary mechanism.

The substrate 1 may be made up of a sheet of plastic, such as PET, with a thickness in a range of 0.1 micrometer up to a few millimeters. Electrode 2 is printed with conducting graphite paste by thick film printing technology. Afterwards, mixture of silver and silver chloride is printed on the substrate 1 to form electrode 3. The printing thickness is in the range of 5 micrometers to 20 micrometers. The functional electrode 4 is similarly formed by printing a paste, which is achieved by mixing with conducting materials such as Au, Pt or Pd, onto substrate 1. Active ingredient, i.e. enzyme catalytic reaction reagent, is deposited in reaction chamber 5 by thick film printing technology to form a guiding channel. It should be understood that other coating methods may be employed, such as injection printing, spraying, and the like. The deposited ingredient is bydrophilic in nature. Otherwise, surfactant may be added into the active ingredient to make it hydrophilic. Thus, a predefined and guided capillary flow channel is appropriately formed. The length of this guiding channel is around 1.5 mm, which may vary from 0.5 mm to a few millimeters or longer depending on applications. Afterwards, a conventional hydrophobic plastic film 6 of transparent, semi-transparent or opaque with or without color, with a thickness in a range of 0.05 mm to 1 mm, preferably about 0.125 mm, is glued onto the top of the substrate 1 and all electrodes. However, above the reaction chamber 5, no glue or adhesives are provided (see FIGS. 2 and 3). That is to say, in the region where the active hydrophilic ingredient is deposited, a gap free of glues or adhesives is formed between the active ingredient layer and the plastic film. The height of the reaction chamber 5 is designed to be from 0.001 mm to 1 mm. A design in which a hydrophilic surface of the active ingredient is faced with a hydrophobic surface of the plastic film 6 further promotes a capillary action. When a testing solution such as a blood sample is applied to the entrance end of the reaction chamber 5, the blood will be quickly sucked into the reaction chamber 5 via capillary mechanism. It usually takes less than 1 second, more preferably less than 0.5 second, for blood to complete the capillary action.

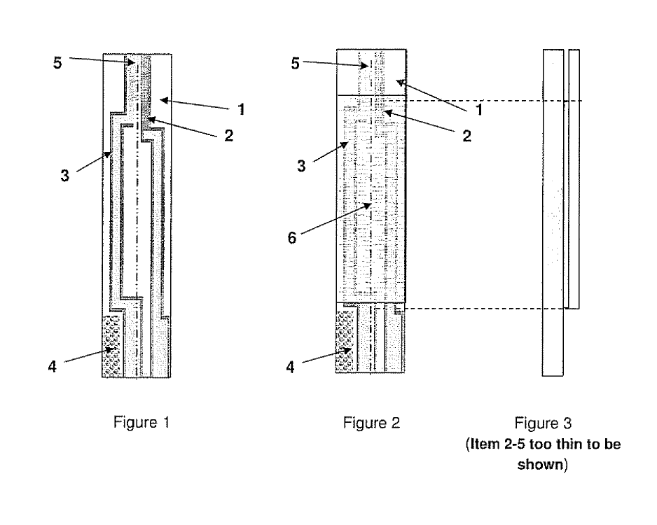

The biosensor shown in FIG. 1 can still perform an accurate analysis even though the sample volume goes down to a very low value, such as within a range of 0.12 μl to 0.24 μl, which is the smallest test volume for a glucose biosensor available today. By further decreasing dimensions of electrodes and reaction chambers, less testing solution is required in an analytic process. For example, in a smaller biosensor, a blood sample with a volume less than 0.1 μl may be sufficient, while the accuracy of the testing result will remain substantially the same. Therefore, by the novel design of the present invention, a sample may be analyzed easily and accurately, even though the volume of the sample is really small.

The entrance of the reaction chamber 5 may be configured to be circular, semi-circular, elliptical, semi-elliptical, rectangular, square, triangular, trapezoidal or any other suitable shapes within the region of the reaction chamber. A combination of these configurations is also possible, depending on the application of the biosensor.

Particularly, electrodes in the present invention are made up of nano materials. Graphite, silver and silver chloride materials are all powders within nanometer range. These tiny powders are dispersed in macromolecular solutions. Therefore, congeries and cavities within nanometer range are developed in electrodes. Thus, reaction area is greatly increased and the accuracy of the analytic tests is greatly improved.

It has been proved that with a biosensor with a pre-defined and guided capillary fill design according to the present invention, a test solution such as blood may be sucked into reaction chamber in a short time less than 1 second, most often in 0.2 second, through capillary mechanism. The analytic volume of the sample may be effectively controlled by changing the length of the guided channel and the height of the reaction chamber. Therefore, a biosensor with present design may operate with a high accuracy and free of blockage.

It should be noted that the embodiment of the present invention shown in the drawings has only one hydrophilic guiding channel within the region of the reaction chamber, however, the device with a predefined capillary fill design according to the present invention can have multiple channels for the same or completely different assays for biological diagnostic or other applications. In this case, it can also deposit different assay reagents to form different artworks together, or separately or combined the two to form multiple assays, for example, several parameters of blood tested in one go.

Although the invention is described in detailed with a medical device such as a biosensor, it is also applicable to any other advanced devices using capillary mechanism to fill a small chamber for quantitative and qualitative analysis. The fields to which the present invention is applicable include but are not limited to biological, chemical, environmental and food science, and the like.

Furthermore, while an embodiment of the present invention has been described with reference to accompany drawings, it is to be understood that the invention is not limited to details of the illustrated embodiments. A person skilled in the art may understand that amendments and modifications can be made without departing from the scope of the present invention as disclosed in the claims. All these amendments and modifications shall fall within the scope of the present invention.

1. A device with a predefined capillary fill design, comprising a substrate (1), a working electrode (2), a reference electrode (3), a functional electrode (4), a reaction chamber (5) and a plastic covering film (6), characterized in that:
the reaction chamber (5) is provided with one or more hydrophilic guiding channels extending from the entrance of the reaction chamber (5).

2. The device with a predefined capillary fill design according to claim 1, wherein the hydrophilic guiding channel is formed by depositing any hydrophilic ingredient on the substrate (1).

3. The device with a predefined capillary fill design according to claim 2, wherein the hydrophilic guiding channel is formed on the substrate (1) by thick film printing, injection printing, spraying, or other coating methods.

4. The device with a predefined capillary fill design according to claim 2, wherein the hydrophilic ingredient is an enzyme catalytic reaction reagent.

5. The device with a predefined capillary fill design according to claim 2, wherein the hydrophilic ingredient is a mixture of surfactant and enzyme catalytic reaction reagent.

6. The device with a predefined capillary fill design according to claim 1, wherein the height of the reaction chamber (5) is within the range of 0.001 mm to 1 mm.

7. The device with a predefined capillary fill design according to claim 6, wherein the length of the hydrophilic guiding channel is no less than 0.5 mm.

8. The device with a predefined capillary fill design according to claim 7, wherein the entrance of the reaction chamber (5) may be configured to be circular, semi-circular, elliptical, semi-elliptical, rectangular, square, triangular, trapezoidal or any other suitable shapes or a combination thereof within the region of the reaction chamber.

9. The device with a predefined capillary fill design according to claim 1, wherein the plastic covering film (6) is a normal hydrophobic plastic film.

10. The device with a predefined capillary fill design according to claim 9, wherein the thickness of the plastic covering film (6) is in the range of 0.05 mm to 1 mm.

11. The device with a predefined capillary fill design according to claim 9, wherein the plastic covering film (6) is transparent, semi-transparent or opaque with or without color.
